(19) United States
(12) Patent Application Publication
(10) Pub. No.: US 2010/0204625 A1
(43) Pub. Date: Aug. 12, 2010

(54) SPINAL THERAPY UNIT

(76) Inventors: Ross Yamamoto, Los Angeles, CA (US); Brandon Saito, Los Angeles, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/369,122

(22) Filed: Feb. 11, 2009

(51) Int. Cl. A61H 7/00

(52) U.S. Cl. 601/151

(57) ABSTRACT

A spinal therapy device comprising an elastomeric sleeve having an opening at each end, a pair of spherical objects held together within said sleeve, means to substantially close one end of the sleeve and means to releasably close the other end of the sleeve.

### FIELD OF THE INVENTION

The invention relates to a device used for the purpose of muscular and spinal therapy.

### BACKGROUND OF THE INVENTION

Placing pressure on both the right and left of the spine, while relaxed and without pressure directly on the spine itself has been known to give relief to patients with certain back problems. However, applying pressure in this manner has only been achieved by another person pressing on the patient's back while the patient lies face down, or by placing spherical objects, which are fixedly held together, under the patient while the patient is lying face up. When the patient relaxes, the spherical objects apply pressure to the right and left of the spine, using the patient's body weight. Recently, two spherical objects held together have also been used directly on the spine, as the spherical objects were placed parallel to the spine, stretching the front of the spine and its ligaments.

In the case of the spherical objects, it has been known to use tape or glue or even old socks to hold the spherical objects so that they do not move away from their desired position. Glues and tapes create a very sticky mess and the spherical objects becomes very dirty, picking up lint or dirt from the carpet or floor due to the adhesive. Wrapping the spherical objects in a sock and knotting the end or binding the open end with a string or tape, resulted in the sock stretching and the sock had to be torn off to readjust or rewrap the spherical objects with another sock. Often it was necessary to throw the dirty, taped spherical objects away, due to their negative appearance to patients.

### SUMMARY OF THE INVENTION

It is therefore the object of this invention to create a device comprising two spheres, held together, without the negative results of the prior art.

The invention comprises two spheres held in a sleeve made of an elastomeric material which holds the spherical objects together in the proper position, yet is comfortable to the touch and firm enough for a patient to lie upon. The spherical objects are removable, and the outer sleeve washable. No glues, adhesives, knots of material, or zippers to catch a patient's hair, when using it in the neck area, are needed. The sleeve utilizes a plastic “cinch lock” attached to a nylon cord that is run through the hem at one end of the sleeve, to allow the opening of the end of the sleeve for removal of the spherical objects. At the other end of the sleeve, the elastic material is tapered to a smaller diameter and a non-stretch stitch is sewn in, to stop the spherical objects from exiting that end of the sleeve.

### BRIEF DESCRIPTION OF THE DRAWINGS

FIG. 1 is perspective view of the invention;

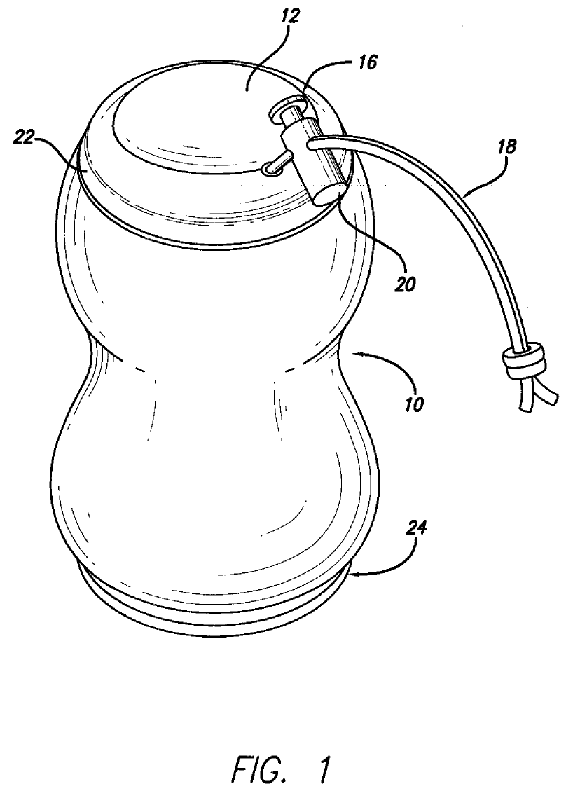

FIG. 2 is a side elevational view;

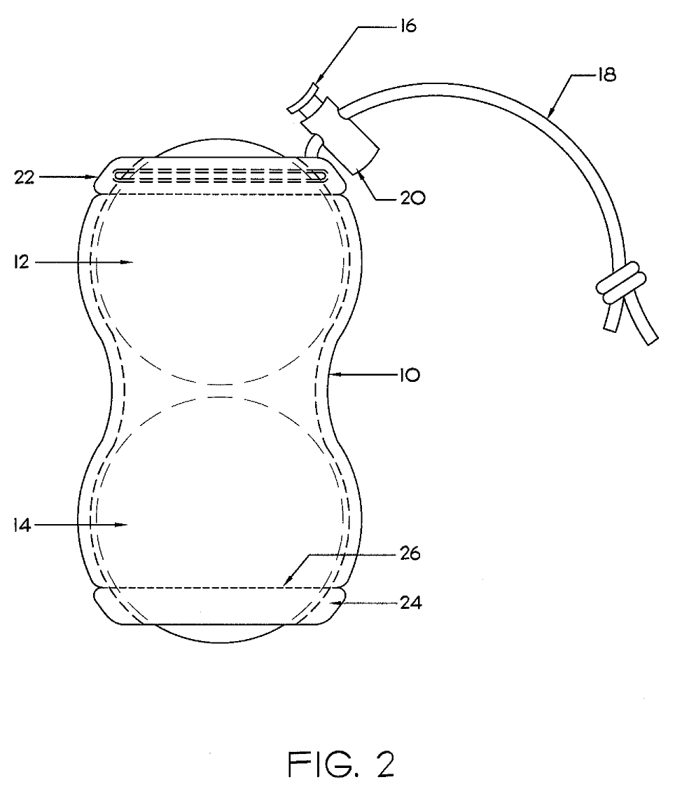

FIG. 3 is a back view; and,

FIG. 4 is a top view.

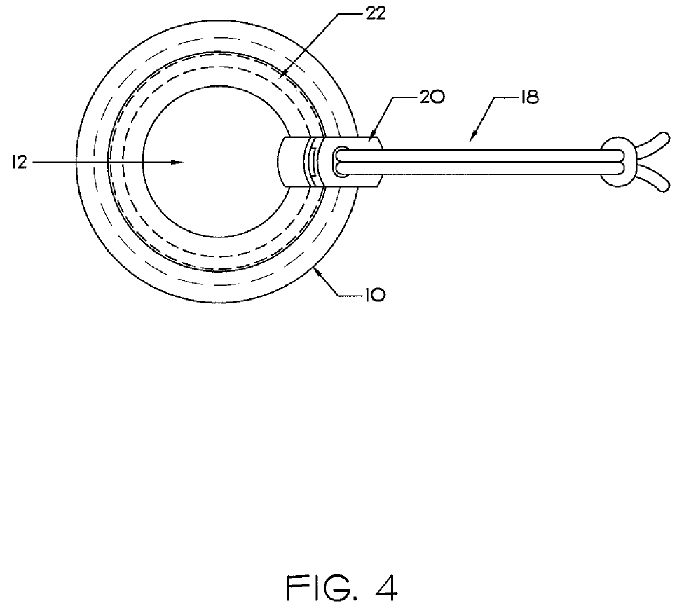

### DETAILED DESCRIPTION OF THE INVENTION

Referring now to the drawings, there is shown a sleeve 10 inside of which is held two spherical objects, or balls, 12 and 14. One end of sleeve 10 has a cinch lock 16 comprising a cord 18 and a locking device 20. Cord 18 passes through hem 22 at one end of sleeve 10. When cinch lock 16 is tightened sufficiently, spheres 12 and 14 are held tightly in sleeve 10. When cinch lock 16 is released, spheres 12 and 14 can be removed from sleeve 10.

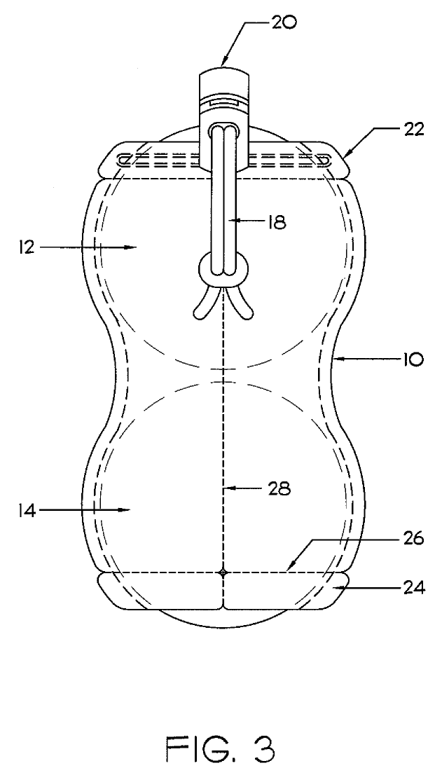

At the other end, sleeve 10 is tapered to a smaller diameter 24 by use of a non-stretch stitch 26 to sufficiently hold spheres 12 and 14 from exiting that end of sleeve 10. Stitch 28 (shown in FIG. 3) closes sleeve 10, in the vertical direction.

Placing the spinal therapy unit of this invention along the spine while lying down on a flat horizontal surface, face up, with one spherical object 12 to the right and the other spherical object 14 to the left of the spine, encased by the sleeve 10, the spherical objects 12 and 14 create a lift from the flat horizontal surface, at the point of contact with the back, while not placing pressure directly on the spine, due to the area void of mass created by the curvature of spherical objects 12 and 14. This lift area allows the spine to bend and stretch the front of the spine, due to the arc created by spherical objects 12 and 14, enclosed by sleeve 10.

When the tendons and muscles are shortened by excess stress or repetitive misuse, they compress the spine and place undue pressure on the discs (pliable “spacers” that the body lubricates with fluid that allows the spine to bend and twist comfortably). Compression causes the discs to swell due to irritation created by the pressure, and adds to the problem of pressure created by the shortened muscles and tendons. This often creates a chronic spinal problem, as the swollen body parts apply pressure on the nervous system, also part of the spine, resulting in pain and discomfort.

The stretching of these tendons and muscles is optimally done by the spinal therapy unit of this invention. Simultaneously applying pressure on the muscle tissue along the right and the left of the spine, the spinal therapy unit also massages the muscles comfortably, yet firmly, as the patient can “roll” back and forth over the surface of the unit, which increases blood flow and reduces fatigue in the area. Lactic acid (a waste product of the muscle after exertion, that causes contraction and restricts oxygen and blood flow) is able to be released from the muscles, due to the massaging effect, which increases blood flow. Continued use of the spinal therapy unit, optionally combined with other medical and physical therapy, has proved to reduce, and in some instances relieve, all discomfort. It is important that the spheres are kept adjacent to one another, and are soft enough to be comfortable, yet firm enough to lift the spine and create the desired curvature from the horizontal position.

Other positions may be used that will give the spinal therapy unit even more benefits. Placing the spinal therapy unit along the spine, and actually lying directly on it face up, places pressure directly on the spine, and when the correct size is used, it presses and positions the spine in a position to stretch two vertebrae at a time. This is a more advanced position.

The massage position can also be achieved by standing up with the spinal therapy unit placed against a wall, with one spherical object to the right and the other spherical object to the left of the spine, encased by the sleeve. Gentle lifting of the body with knees slightly bent applies pressure on the unit and concurrently massages the muscles to the right and left of the spine.

Sleeve 10 is preferably a cylinder of neoprene, although it can be made of other elastomeric fabric. It is designed to be compact, washable, and have an appealing look and feel. At one end, cord 18, preferably made of nylon, is passed through hem 22 and when tightened and secured by a cord lock 20, holds the two spheres 12 and 14 together, yet, by releasing cord lock 20, allows the removal or insertion of the spheres for replacement or cleaning of sleeve 10 and/or spheres 12 and 14, or the replacement of the two spheres with spheres of a different size.

At the opposing end, sleeve 10 is tapered to a smaller diameter and sewn with a non-stretch stitch 26. This allows minimal flexibility and prevents the spherical objects from exiting at that end. All other stitching is of a stretch nature and moves with the elastomeric fabric. When the spinal therapy unit is complete, with the correct size spherical objects in place, the tapered end is not apparent and looks very neat, matching the opposite side when the nylon cord is cinched down and the cord lock is secured.

Neoprene is the preferred material for the sleeve, because it has the proper elastomeric properties and is easy to clean. It may be from about ½ mm thick to about 5 mm thick. The spherical balls are preferably made of semi-hard rubber so that they have some flexibility but still maintain their shape, in order to press on the sides of the spine for proper massage. The stiffness of the spheres may vary depending on what works best for the patient. The spheres may be tennis balls or wooden spheres, although something in-between in hardness is usually preferable, such as rubber or a polymer. The spheres may vary in size from about 1 inch in diameter up to about 16 inches in diameter, depending upon the needs of the patient.

Having thus described the invention, we claim:

1. a spinal therapy device comprising an elastomeric sleeve having an opening at each: end thereof, a pair of spherical objects held together within said sleeve, means to substantially close one end of the sleeve and means to releasably close the other end of the sleeve.

2. The spinal therapy device of claim 1 in which one end of the sleeve is closed sufficiently to stop the spherical objects from exiting that end of the sleeve.

3. The spinal therapy device of claim 2 in which the end of the sleeve is closed by a non-stretchable stitch.

4. The spinal therapy device of claim 1 in which the pair of spherical objects are the same size.

5. The spinal therapy device of claim 1 in which one end of the sleeve comprises a hem through which passes a cord, having means to tighten the cord sufficiently to prevent the spherical objects from exiting the sleeve.

6. The spinal therapy device of claim 1 in which the sleeve is made of neoprene.

7. The spinal therapy device of claim 1 in which the spherical objects are made of rubber.

8. The spinal therapy device of claim 5 in which the means to tighten the cord is a cinch lock.

9. A spinal therapy device comprising an elastomeric sleeve having an opening at each end thereof, a pair of spheres held together within said sleeve, one end of said sleeve being closed sufficiently by a non-stretch stitch to prevent the spheres from exiting the sleeve and the other end of the sleeve being closed sufficiently by a cord passing through a hem at that end of the sleeve to prevent the spheres from exiting the sleeve.

10. The spinal therapy device of claim 9 in which the cord is tightened by a cinch lock.

11. The spinal therapy device of claim 9 in which the pair of spheres are held together so that they touch each other.

12. The spinal therapy device of claim 9 in which the sleeve is made of neoprene.

13. The spinal therapy device of claim 9 in which the spheres are made of rubber.

14. A spinal therapy device comprising a neoprene sleeve having an opening at each end thereof, a pair of equally sized rubber spheres held together to touch each other within said sleeve, one end of said sleeve being closed sufficiently by a non-stretch stitch to prevent the spheres from exiting the sleeve and the other end of the sleeve being closed sufficiently by a cord, passing through a hem at that end of the sleeve, the cord having a cinch lock to prevent the spheres from exiting the sleeve.

15. A method for massaging both sides of the spine comprising lying down on a flat horizontal surface, face up, having a spinal therapy device placed under the spine, said spinal therapy device comprising a neoprene sleeve having an opening at each end thereof, a pair of equally sized spheres held together to touch each other within said sleeve, one end of said sleeve being closed sufficiently by a non-stretch stitch to prevent the spheres from exiting the sleeve and the other end of the sleeve being closed sufficiently by a cord, passing through a hem at that end of the sleeve, the cord having a cinch lock to prevent the spheres from exiting the sleeve, with one sphere on each side of the spine, and moving forward and backward on top of the spinal therapy device.
